(19) United States
(12) Patent Application Publication
(10) Pub. No.: US 2023/0267512 A1
(43) Pub. Date: Aug. 24, 2023

(54) SYSTEM AND METHOD FOR VALIDATING PODCAST MEDIA REACH

(71) Applicant: Ossa Collective Inc., Tenafly, NJ (US)

(72) Inventors: Marla Isackson, Tenafly, NJ (US); Anne Kavanagh, Los Angeles, CA (US); Ulemar Olibano Rosas, JR., New York, NY (US)

(21) Appl. No.: 17/675,234

(22) Filed: Feb. 18, 2022

(51) Int. Cl. G06Q 30/02; G06F 40/20; H04L 51/02

(52) U.S. Cl. CPC G06Q 30/0282; G06F 40/20; H04L 51/02

(57) ABSTRACT

Disclosed are systems and methods for measuring and validating the reach of podcast media content. The systems and method are realized using a server provided within the podcast distribution network and in communication with podcast host servers, streaming platform servers, social media servers, a first party data aggregator server and a third-party data aggregator server. The system server's processor comprises a data aggregation module (DAM) for capturing podcast information from a third-party data aggregator and validating that “unverified” third-party data against trusted Podcast Information obtained from first-party Podcast Information sources. Additionally, the processor comprises a matching engine configured to automatically generate advertising campaigns connecting advertisers with matching podcasts based on the validated Podcast Information. Furthermore, the processor includes an analytics engine configured to algorithmically develop deeper insights into podcast information using machine learning techniques and generate recommendations for podcasts to improve performance.

### FIELD OF THE DISCLOSURE

The present disclosure relates to systems and methods for monitoring the distribution of podcast media content. In one particular arrangement, the present disclosure describes a system and method for efficiently compiling and validating metrics representing the reach of podcast media content.

### BACKGROUND OF THE DISCLOSURE

Podcasting is a method of publishing digital audio and video programs via the Internet. Podcasts are offered in a syndication format in which the content is provided in the form of a feed of digital media files (e.g., shows/episodes) that users can subscribe to. Accordingly, a given feed and its content files are associated with a respective podcast and the “podcaster,” which refers to the individual or individuals that provide the podcast. Podcasts are distinct from other types of online digital media content and delivery systems (e.g., online videos posted to a website) because of the subscription-based nature of the podcasting and the delivery mechanism using feeds, such as RSS feeds.

The RSS format is an example of a simple XML-based format that allows users to subscribe to content available for download from podcast hosting companies. An RSS feed comprises an association of files using the RSS format. Typically, for a podcast to “go live,” the podcast content (e.g., a media file for a given episode) is provided in an RSS feed connected with a hosting company. There are a large number of hosting companies that typically operate independently and are closed systems that do not openly share data. The hosting company pushes the RSS feed out to streaming platforms, such as Spotify, Apple iTunes, Soundcloud and the like. Similarly, the streaming platforms commonly are independent of one another, capture different sets of data and often do not provide transparency into the data. For clarity, “data” and “metrics” is used to refer to the information specific to a podcast that represents the reach of the podcast. Reach data encompasses measurable information about the consumption of a podcast, e.g., how many people download and/or listen to a podcast in a given period of time, how long they listened, what portions of the content were consumed, when, etc. Reach can also include information about respective users/listeners such as age, gender, socio-economic background, and other such demographics information. A podcast or podcaster's reach can also include reach on other networks beyond the podcast distribution network such as social networks, email marketing, a podcast's website, and other methods for connecting the podcast or podcaster to end users and content consumers.

There are various practical and technical inefficiencies that are rooted in the particular form of Podcast media content, the manner in which Podcast media is distributed through hosting companies that are typically independent and closed, and the infrastructure used to distribute podcasts.

There is a need in the art for a system that can efficiently compile the data and metrics relating to the “reach” of a Podcast through disparate and often closed distribution channels. Further, there is a need for efficiently and accurately validating the compiled data and metrics. There is further a need to provide a system that leverages the compiled and validated podcast information to enable podcasters to effectively market their podcast, expand their reach through the various channels. There is further a need to provide a system that leverages the compiled and validated podcast information to match advertisers (“Brands”) with suitable podcasters and efficiently facilitates the placement of Brand advertisements with the suitable podcasters irrespective of how small or large the podcaster's reach is.

It is with respect to these and other considerations that the disclosure is directed.

### SUMMARY OF THE DISCLOSURE

According to a first aspect of the disclosure, a system is provided for validating a reach of podcast media content within a podcast distribution network environment, wherein the podcast distribution network includes one or more of a podcast host server, a streaming platform server, a social media server, a first party data aggregator server and a third-party data aggregator server. In particular, the system comprises a system server including a communication network interface communicatively connecting the system server with one or more servers within the podcast distribution network environment, and a non-transitory computer readable storage medium. The system server also includes a processor in electronic communication with the computer readable storage medium and the communication network interface, and one or more software modules comprising executable instructions stored in the storage medium and executable by the processor.

More specifically, the software modules include a data aggregation module (DAM) that configures the processor to, for each respective podcast among a plurality of podcasts, capture Podcast Information for a respective podcast from the third-party data aggregator server. In particular, the Podcast Information comprises Podcast Data and Social Data, wherein Podcast Data includes information relating to the respective podcast's distribution and attribution, and wherein Social Data includes usage data and metrics relating to a social media reach of the respective podcast. The Podcast Information obtained from the third-party data aggregator server is referred to as untrusted Podcast Information.

The DAM also configures the processor to capture trusted Podcast Information for the respective podcast. Trusted Podcast Data is obtained from one or more of an RSS data feed for the respective podcast, the podcast host server, and the streaming platform server, and trusted Social Data is obtained from one or more social media and marketing platforms. Additionally, the trusted Podcast Information is obtained directly by the DAM or is captured indirectly from the first-party data aggregator server.

The DAM also configures the processor to store the Podcast Information, including trusted and untrusted Podcast Information, in a database in association with a respective account for the respective podcast. Additionally, the untrusted Podcast Information is annotated in storage as being unvalidated data.

The software modules also includes a validation tool that configures the processor to, for each respective podcast among the plurality of podcasts, validate the untrusted Podcast Information for the respective podcast according to the trusted Podcast Information for the respective podcast. More specifically, validating the Podcast Information includes comparing one or more untrusted Podcast Information data points with one or more corresponding trusted Podcast Information data points, and validating the respective podcast as a function of the trusted Podcast Information matching the untrusted Podcast Information to a prescribed degree. Furthermore, the processor is further configured to output a validation status indicating that the respective podcast is validated.

According to a further aspect, a method is provided for validating a reach of podcast media content within a podcast distribution network environment, which includes one or more of a podcast host server, a streaming platform server, a social media server, a first party data aggregator server and a third-party data aggregator server, the method being implemented by a processor of a system server. The method comprises the step of capturing, by a data aggregation module of the processor, Podcast Information for a respective podcast from the third-party data aggregator server. In particular, the Podcast Information comprises Podcast Data and Social Data, wherein Podcast Data includes data points relating to the respective podcast's distribution and attribution, and wherein Social Data includes data points relating to a social media reach of the respective podcast. Additionally, Podcast Information obtained from the third-party data aggregator server is referred to as untrusted Podcast Information.

The method also includes the step of capturing, by the data aggregation module of the processor, trusted Podcast Information for the respective podcast. In particular, trusted Podcast Data is obtained from one or more of an RSS data feed for the respective podcast, the podcast host server, and the streaming platform server, and trusted Social Data is obtained from one or more social media and marketing platforms. Moreover, the trusted Podcast Information is obtained directly by the processor or is captured indirectly from the first-party data aggregator server.

The method also includes the step of storing, by the data aggregation module in a database, the Podcast Information including trusted and untrusted Podcast Information. Specifically, the Podcast Information is stored in association with a respective account for the respective podcast, wherein the untrusted Podcast Information is annotated in storage as being unvalidated data.

The method also includes the step of validating, by a validation engine of the processor, the untrusted Podcast Information for the respective podcast according to the trusted Podcast Information for the respective podcast. In particular, validating includes the steps of comparing one or more untrusted Podcast Information data points with one or more corresponding trusted Podcast Information data points, and validating the respective podcast as a function of the trusted Podcast Information matching the untrusted Podcast Information to a prescribed degree. Furthermore, validating includes the step of outputting a validation status indicating that the respective podcast is validated.

These and other aspects, features, and advantages can be appreciated from the accompanying description of certain embodiments of the disclosure and the accompanying drawing figures and claims.

### BRIEF DESCRIPTION OF THE DRAWINGS

The foregoing and other features of the arrangements of the present disclosure will be more readily apparent from the following detailed description and drawings of an illustrative embodiment of an invention encompassed by the disclosure.

FIG. 1A is a conceptual diagram illustrating an example of a podcast and social media network environment including a system for validating the reach of podcast media content, according to the principles of the disclosure;

FIG. 1B is a conceptual diagram illustrating an example configuration of a processor of the system for validating the reach of podcast media content constructed according to the principles of the disclosure; and

FIG. 2 is a flow diagram illustrating an example routine for validating the reach of podcast media content constructed according to the principles of the disclosure.

### DESCRIPTION OF CERTAIN EMBODIMENTS OF THE DISCLOSURE

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment may be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure may be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

By way of overview and introduction, the present application describes a computer platform (referred to as the “Ossa platform” or “platform”) for measuring and validating podcast reach data, for connecting advertisers with podcasts and podcast creators, to target podcast audiences based on validated reach, for enabling podcasters to better monetize their content and algorithmically develop deeper insights into podcast reach data using machine learning techniques. Although a podcast is created by a podcaster, for ease of reference, podcast and podcaster can be used interchangeably herein. The platform is the computing backbone of the greater Ossa network (the Ossa network is a podcaster network and platform operated under the trademark Ossa™ by Heart of Gold US LLC of New Jersey d/b/a Ossa, www.ossacollective.com) comprising three primary users including podcasters, advertisers and the Ossa network team.

As noted, there are various practical and technical inefficiencies that are rooted in the particular form of podcast media content, the manner in which podcast content is distributed through hosting companies, which are typically independent and closed, and the infrastructure used to distribute podcasts. Embodiments of the disclosure provide a system that can efficiently compile the data and metrics relating to the reach of a Podcast through disparate and often closed distribution channels. Further, embodiments of the disclosure provide a system that efficiently and accurately validates the compiled data and metrics. System and methods of the present disclosure beneficially leverage the compiled and validated podcast information to enable podcasters to effectively market their podcast, expand their reach through the various distribution channels. The systems and methods of the present disclosure further provide a system that leverages the compiled and validated podcast information to match advertisers (“Brands”) with suitable podcasters and efficiently facilitates the placement of Brand advertisements with the suitable podcasters irrespective of how small or large the podcaster's reach is.

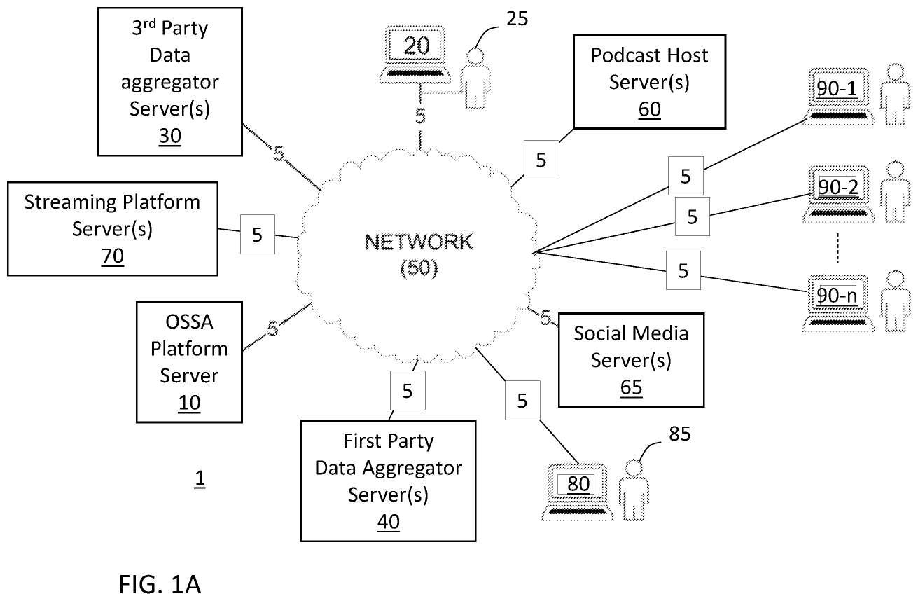

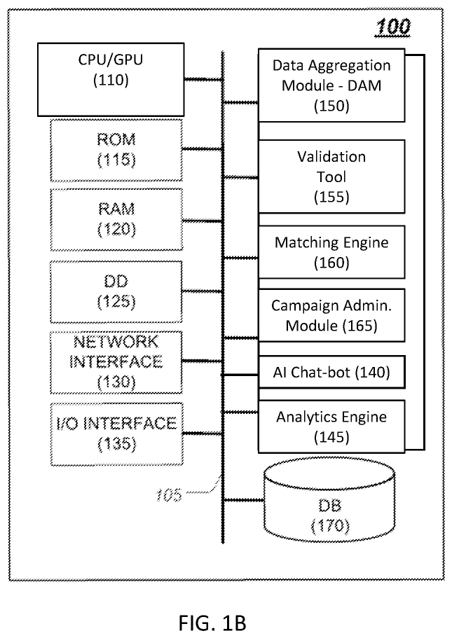

FIG. 1A shows a non-limiting example of a computing system environment 1 for distributing digital podcast and social media content over a network (e.g., the internet) provided with a technological solution for validating the reach of podcast media content according to the principles of the disclosure. As shown in FIG. 1A the system 1 includes the platform system server 10. The system also comprises a podcaster computer 20, which is operated by a podcaster 25 to for example and without limitation, create and publish podcast content and access the system server 10 in order to utilize the features and functionality provided by the system server 10. Additionally, the system 1 includes an advertiser computing device 80, which is operated by an advertiser 85 and is in communication with the system server 10 to enable the advertiser to utilize the features and functionality provided by the system server 10.

The podcast distribution environment 1 can also comprise additional computing systems that are in operative communication with the system server 10 and that facilitate various features and functionality provided by the server 10. In particular, the system can include one or more podcast hosting company server(s) 60, one or more social media server(s) 65, one or more streaming platform server(s) 70, one or more third party data aggregator server(s) 30 and one or more first party data aggregator server(s) 40. Additionally, as shown, the system 1 further comprises the respective computers 90-1, 90-2 . . . 90-n, which are used by respective end-users (also referred to as “listeners,” or “consumers,” or “subscribers”) to access podcasts and related digital content. The various components in the podcast distribution system environment 1 can be communicatively coupled to each other directly via communication links 5, or via communication links 5 and the network 50.

As would be understood, in a typical use case of the podcast distribution environment 1, the Podcaster 25 generates podcast content (e.g., a media file for each given episode) and publishes the content from the Podcaster's computer 20 to one or more podcast hosting company server(s) 60. The hosting company server 60 pushes the podcast content in the form of RSS feeds out to one or more streaming platform servers 70. The streaming platform servers 70 represent, for example, the media distribution servers associated with one or more commonly known streaming services such as Spotify™ (Spotify Technology S.A. of Sweden), Apple iTunes™ (Apple Inc. of Cupertino Calif.), SoundCloud™ (SoundCloud Ltd. of Berlin, Germany), and the like. The one or more streaming platform servers 70 provide the end users with access to the podcast content via their respective computing devices, 90-1, 90-2 . . . 90-n. In some embodiments, the podcaster and/or the podcast hosting company can deliver RSS feeds including the podcast content directly to the listener computing devices 90-1 . . . 90-n via communication links 5.

As shown in FIG. 1A, the podcast distribution environment 1 can also include one or more social media servers 65. Social media server 65 represents various social media platforms and other such computing systems/networks that are used to connect podcasters, listeners, advertisers and the like. For example, social media server 65 can represent servers associated with popular social media platforms including Twitter™ (Twitter Inc., San Francisco, Calif.), Linkedln™ (Microsoft, Inc., Mountain View, Calif.), Instagram™ and Facebook™ (Facebook Inc., Menlo Park, Calif.), and the like. Social media server 65 can also represent servers associated with other content distribution, marketing and communications systems such as the streaming video platform YouTube™ (Google Inc. of Mountain View, Calif.), the website usage data and analytics platform Google Analytics™ (offered by Google Inc. of Mountain View, Calif.), the email marketing system Mailchimp™ (Mailchimp Inc. of Atlanta, Ga.) and the like.

As shown in FIG. 1A, the podcast distribution environment 1 can also include one or more third-party data aggregator servers 30, and one or more first-party data aggregator servers 40. Third party and first party data sources, as further described herein, are intended to refer to various aggregators of data and information relating to podcasts and podcasters.

It should be understood that FIG. 1A illustrates a non-limiting example of a podcast distribution system environment 1. Moreover, although some devices are shown and described as comprising a single device this is not intended to be limiting as any number of such systems can be integrated with the system and in data communication with the System server 10.

FIG. 1B shows a non-limiting embodiment of a processor 100 of the platform system server for implementing one or more aspects of the solution for measuring and validating podcast reach data, according to the principles of the disclosure.

In at least one aspect, the system server 10 comprising the processor 100 is configured to implement various methods for compiling, quantitatively measuring and validating data representing the reach of podcast content that is delivered to end users through a computer network (e.g., podcast distribution environment 1). This quantitative podcast reach data measurement and management processor 100 centralizes podcast data and podcast social media data from various disparate sources, enabling quantitative analysis and validation of a podcast's reach and growth. The processor is configured to provide users with a centralized dashboard user interface that empowers the platform, podcasters and advertisers to gain deeper insights into podcaster audiences on the network, place more effectively targeted advertising and validate the podcaster's data in one system.

The processor provides insight for various user groups of the system server 10. With respect to podcasts the processor is configured to automatically retrieve, centralize and validate their data in one place including but not limited to downloads, demographics, monthly growth, placement in charts and social media statistics. With respect to advertisers, the system server 10 is configured to validate podcaster data and provide better insight into podcaster statistics and reach. This enables the advertisers to, using the platform, increase Brand safety and place advertising more strategically. With respect to the provider of the platform and related services (i.e., the “Ossa network Team”), the system server 10 is configured to facilitate the placement of advertisements more effectively, automatically, and reliably validates podcaster statistics thereby providing added value for its customers.

As further described herein, the system server 10, particularly the processor 100 comprises a plurality of functional modules.

### Data Aggregation Module:

In an embodiment, the processor 100 comprises a data aggregation module (“DAM”) 150. The DAM is configured for the collection and management of data relating to podcast reach in combination with other social media metrics representing the podcast's social media and marketing presence (e.g., Twitter, Instagram, Facebook and other social media platforms). The DAM also integrates with a business intelligence and analytics module 145 configured to analyze and present such information and further insights derived therefrom to users on a user-interface such as a web-based dashboard or chat interface. Such data is obtained for each podcaster and maintained by the DAM in an individual account in the database 170. The plurality of podcaster accounts and data can be aggregated as well into a master account maintained in the database 170. The individual and collective data is managed in a manner that enables the processor 100 to leverage individual and collective data for quantifying the reach of individual podcasters and a collection of podcasters, and deriving deeper analytics on podcasts individually and collectively.

Podcast Data can be automatically captured by the DAM from any number of a variety of podcast media outlets including RSS feeds, podcast hosting platforms server(s) 60 and podcast streaming platform server(s) 70. For reference, Podcast Data comprises data pertaining to podcast distribution (e.g., downloads, streams) and attribution metrics. For example, and without limitation, the types of data points that make up Podcast Data and that can be obtained by the DAM for a podcast is listed in the following Table 1.

TABLE 1
Podcast Name/ID
A power score (accumulation),
Estimated monthly listens,
Category/Genre (e.g., true crime, business,
lifestyle, society),
Gender skew,
Median listener age.
Median listener income,
Listener marital status skew,
Apple chart positions,
Podcast details: status (active/inactive), release
period, # of episodes, hosting provider, iTunes ID, etc.
Average daily reach
Number of posts

| | |
|---|---|
| Episode name | Number of downloads (thirty day measurement, total |
| Episode date | measurement, and trailing thirty day reach) |
| Provider | (for each episode) |
| (for each episode) | Number of streams (thirty day measurement, total |
| | measurement, and trailing thirty day reach) |
| | (for each episode) |
| | Number of unique devices (thirty day measurement, |
| | total measurement, and trailing thirty day reach) |
| | (for each episode) |

Social Media data (“Social Data”) that can be automatically captured, compiled and utilized by the DAM 150 can include the usage data and metrics available from social media and marketing platforms including, for example, Facebook, LinkedIn, Instagram, Twitter, YouTube, Google Analytics, Mailchimp and the like. Social Data and Podcast Data are collectively referred to as Podcast Information. In some embodiments, Social Data can be obtained by the DAM 150 directly from the social media server(s) 65 associated with respective social media and digital marketing platforms.

For example, and without limitation, types of data points that define Social Data and that can be obtained by the DAM for a Podcast is listed in the following Table 2.

TABLE 2
Podcast/Podcaster Name
Website address - website traffic/metrics - website traffic demographics
Facebook account - Number of followers- follower demographics -
activity metrics
Twitter account - Number of followers - follower demographics -
activity metrics
Instagram account - Number of followers - follower demographics -
activity metrics
LinkedIn account - Number of followers - follower demographics -
activity metrics
Mailchimp account - Number of subscribers - subscriber demographics -
activity metrics

It should be understood that, in connection with the onboarding of a podcaster, the processor 100, particularly the DAM 150, can obtain the appropriate user logins and passwords and other such information necessary to access and obtain the data maintained by respective first-party data sources on behalf of the podcaster (e.g., social media server(s) 65, podcast host server(s) 60, streaming platform server(s) 70 and the like).

In some embodiments, the Podcast Information comprising Podcast Data and Social Data can be obtained by the DAM 150 from one or more other aggregators of first-party and/or third-party data (e.g., third party data aggregator server(s) 30 and first party data aggregator server(s) 40 of FIG. 1A). Some data aggregators, such as the aggregator operating under the name Podchaser (Podchaser Inc.), compile various pieces of publicly available information concerning podcasts and make this information available on the internet. Because such aggregators or their sources often do not have first-hand access to the podcast hosting, streaming or social media accounts for respective podcasts, they are referred to as “third-party data” sources that provide unvalidated (also referred to as unverified or untrusted) “third-party data.”

In an embodiment, the DAM 150 is configured to capture at least a portion of the Podcast Information from a third-party data aggregator. For instance, the DAM can retrieve, via an application programming interface (API) call to a 3^{rd} party data aggregator server 30, unvalidated third-party Podcast Information for a given Podcast. The DAM can store the retrieved Podcast Information to the database 170 in association with a unique account for the given Podcast. The retrieved third-party Podcast Information can include at least a portion of the Podcast Information listed in tables 1 and 2, and typically includes a subset of such information.

Capturing third-party Podcast Information from a third-party data aggregator enables the DAM to efficiently populate the database account (also referred to as “profile”) for a given podcast with Podcast Information and streamlines the onboarding of the podcast into the Ossa network managed by the system server 10. Additionally, the Podcast Information collected from the third-party source can be the same Podcast Information that can be displayed to other users of the platform such as advertisers. Additionally, as further described herein, one or more of the Podcast Information data points available from the third-party source can also be used by the system server to generate advertising campaigns targeted according to prescribed parameters and to enable users, like advertisers, to search for, filter and review podcasts within the Ossa network according to the Podcast Information.

Because of the unvalidated nature of the third-party data, the captured Podcast Information data points can be stored in a manner that reflects the unvalidated nature of such third-party data. For example, the profile maintained by the platform for a given Podcast can comprise a data structure dedicated to storing the third-party Podcast Information. By way of further example, all Podcast Information can be stored in a data structure with any values obtained from third-party sources identified accordingly (e.g., flagged as untrusted or unvalidated).

Because of the unvalidated nature of the third-party unvalidated data, the DAM 150 is also configured to capture trusted “first-party” Podcast Information relating to a given Podcast from one or more sources of first-party Podcast Information. In particular, the DAM can be configured to connect to and obtain first-party Podcast Data from one or more first-party data aggregators, that obtain Podcast Data directly from first-party information sources, such as the podcast hosting and streaming platform servers. In an embodiment, the DAM is configured to connect, via an API call, to a first party podcast data aggregator server 40, such as Chartable.com (Chartable Inc., New York, New York). Chartable, for example, is a data aggregator that pulls in, aggregates, and normalizes all Podcast Data for a given podcast directly from the podcast's RSS feeds which is provided to hosting companies and then distributed to listeners directly or via streaming platforms such as Apple iTunes, and Spotify accounts.

In an embodiment, the DAM 150 is also configured to connect, via an API call, to social media server(s) 65 to obtain first-party Social Data for accounts held by the given podcast on networks such as Facebook, Instagram, YouTube, Google Analytics, MailChimp, LinkedIn and other such online services that a given podcast might be registered with and use in connection with podcasting (e.g., creating, distributing, marketing or otherwise running the Podcast) and that collect data relating to that usage. As the Podcast Information gathered from first-party data sources is obtained using a podcast's accounts and associated access permissions, such Podcast Information is referred to as validated (or trusted or verified) “first-party” Podcast Information.

In an embodiment, the DAM 150 can pull and compile third-party Podcast Information and first-party Podcast Information from respective sources on an individual podcast level and store such information in a cloud-based database 170, such as an Amazon Simple Storage Service (“S3”) bucket. In an embodiment, the DAM can be configured to compile all of the data associated with respective enrolled podcast accounts together into a master account in the database 170. As further described herein, the storage of Podcast Information for individual podcasts and aggregated Podcast Information for multiple podcasters facilitates the analysis of such information using various machine learning and analytical tools and the searching of such information by advertisers.

### Validation Tool

Because of the unvalidated nature of the third-party unvalidated data, the System server 10, particularly the processor 100, comprises a podcast reach data validation module 155 (“Validation Tool”). The Validation Tool is configured to validate the third-party Podcast Information in view of the first-party Podcast Information that is available for a given Podcast.

In an embodiment, the Validation Tool is configured to compare one or more third-party Podcast Information data points with one or more corresponding first-party trusted Podcast Information data points. For instance, the Validation Tool can compare the number of downloads/month data point obtained from the third-party data source to one or more corresponding data-points obtained from a first party data source to verify whether the third-party data point is accurate to an acceptable degree. In this manner, the Validation Tool can verify the third-party Podcast Data based on the corresponding first-party Podcast Data and notify users as to the validated/trusted nature of the podcaster's data.

In some embodiments, the Validation Tool can perform cross-channel validation of third-party Podcast Data with Social Data and vice versa. For instance, the reach of a Podcast as reflected by the Podcast's downloads per month can be validated against the number of followers the Podcast has on social media sites such as Facebook or Instagram. As an example, the Validation Tool can be configured to not validate a Podcast's monthly listener data point where the Podcast purportedly has a large number of downloads/month but a disproportionately lower number of social media followers, which is indicative of artificially inflated or inaccurate downloads/month statistics. By way of further example, the Validation Tool can be configured to correlate the email list for a Podcast's email messaging campaign, with streaming data metrics (e.g., downloads and streams per month), and social media metrics (e.g., friends/followers).

In some embodiments, Podcast Information can be validated on an individual data-point level or based on a combination of data points. In some embodiments, validation can also involve calculating a score representing how closely the one or more data points being validated match one or more other trusted data points.

The Validation Tool can validate a multitude of different third-party Podcast Data points based on first-party Podcast Data including, for example, downloads per period (e.g., day, week, 30 days), total reach, day over day downloads, growth, demographics, and the like.

In some embodiment, the Validation Tool can be configured to deem a podcast to be “validated” based on the validation of one or more salient Podcast Information data points. In some embodiments, a podcast can be deemed “validated” based on a weighted average of the validation scores respectively calculated for one or more salient data points exceeding a prescribed threshold. Upon validation of a podcast, the Validation Tool can be configured to annotate the Podcast account/profile with a validation status (e.g., “Validated”). The validation status of a podcast and/or respective Podcast Information data point can be presented to users and further inform other features and functions of the Platform including operation of the matching engine.

As can be appreciated, the type of Podcast Information that is available from respective third-party or first party data sources, which are often operated independently and as closed systems, can differ from source to source. This results in an inconsistent, unstructured, and unstandardized set if simply compiled. Accordingly, in some embodiments, the Validation Tool and DAM can be configured to translate the various data points obtained from these disparate information sources, which are inherently difficult for a computer employing existing data-processing and analytical systems to understand and therefore are not suitable for deeper data-analysis, into a Podcast Information data set that is accurately and more precisely structured according to a common paradigm. Thus, the disclosed embodiments are specifically configured to generate new and enhanced sets of Podcast Information data that are more meaningful in multiple dimensions for at least the reason that they are richer in information than the original data set and are suitable for further data-analytics processes such as benchmarking, matching or statistical analyses, thereby allowing even deeper and more meaningful insights to be drawn therefrom.

The automated solution provided in accordance with embodiments of the invention provides efficiency in the fields of data storage and data analysis, specifically, classification and a more optimized use of computer resources necessary as part of the analytical process. This automated solution, rooted amongst a computer and network-centric arrangement including, by a hardware processor and other machine interaction over a network, facilitates the creation of Podcast Information data sets through the algorithmic analysis of the unstructured received information, validation and selective recordation or translation of information contained therein according to specific classification systems and related criteria, and further augmentation of the received information and thereby transforms unclassified and unstructured Podcast Information into sets of accurate, precise, validated and standardized Podcast Information that not only exceeds the utility of the input information but is also in a condition for deeper levels of analysis and processing.

### Matching Engine

In an embodiment, the System server 10, particularly the processor 100, comprises a Matching Engine 160 that is configured to leverage validated Podcast Information to automatically build advertising campaigns for advertisers (e.g., advertiser 85 of FIG. 1A, also referred to as a “Brand”) by matching the Brand with podcasters according to prescribed criteria.

The processor 100 is configured to generate and output a brand user interface (UI) to the advertiser 85 via the advertiser's computer 80. The brand UI includes a graphical user interface (GUI) with interactive data fields configured to allow the advertiser 85 to input campaign criteria via the computer 85. Campaign criteria can include for example, a specific attribute for one or more of the Podcast Information parameters identified in Table 1 and 2. For example, a set of campaign criteria can specify that the brand wishes to advertise through podcasts having a listener base that is predominantly female, has an average listener age of thirty-five (35), and 5,000 minimum monthly impressions (streams/downloads). Additionally, the campaign criteria can include one or more budget-related parameters, which the brand can define via the brand UI. As would be understood in the art, from a budget, various budget-related parameters can be derived, for instance, the overall campaign budget can be divided by cost-per-mille (CPM) rate for a given ad type, which equals the amount per impression.

In an embodiment, the Matching Engine 160 is configured to use the campaign criteria and the database 170 of Podcast Information for respective podcasts, to identify matching podcasts, which meet the campaign criteria to a prescribed degree. Additionally, the Matching Engine can be configured to identify Podcasts that match one or more of the criteria, rank the Podcasts based on how closely they match the various campaign criteria. The Matching Engine can also generate a list of recommended podcasts based on the matching and ranking for output to the advertiser via the user interface displayed on the Advertiser's computer 80. Additionally, the Matching Engine can be configured to prioritize podcasts having verified accounts with validated data in the list of recommended podcasts. For instance, podcasts having an account with Chartable used by the Validation Tool 155 to validate Podcaster Data can be prioritized over unvalidated podcasters.

In an embodiment, the Matching Engine 160 can generate a list of recommended podcasts for display to the advertiser that includes only enough podcasts that collectively would make up the defined campaign budget within a prescribed margin. For instance, the recommended podcast list can include podcasters that collectively represent −/+$1k of the campaign budget.

In an embodiment, the recommended podcasts can be presented to the brands via the brand UI displayed on the advertiser's computer 80. The Matching Engine 160 can present the podcasts and respective podcast attributes including those attributes of interest to the Brand(s). Additionally, the Matching Engine can be configured to generate an interactive user interface through which the Brands can accept or reject a podcast. The Matching Engine can be configured to dynamically update the list and presentation of recommended podcasts in view of the rejection of a podcast, for instance, by replacing the rejected podcast in the list with another podcast that is similar to the rejected one or otherwise meets one or more of the campaign criteria, and that qualifies for the reach and budget requirements.

In some embodiments, the Matching Engine is also configured to generate an interface that includes buttons enabling the Brand to submit an order for the proposed campaign comprising the list of recommended podcasters (e.g., after the Brand is satisfied with the proposed recommended podcast list and campaign).

The Matching Engine 160 can also be configured to, in response to the order, automatically generate a notification that is transmitted to the podcasters in the approved list of recommended podcasts notifying them that the brand wants to place the order. The notification can be configured for presentation via the computer 20 and can include an interactive user interface with which the podcaster 25 can reply with an acceptance or decline of the offer.

As can be appreciated the rejection of an offer by a podcaster can trigger the Matching Engine to dynamically update the list of recommended podcasts with one or more alternative podcasts and present the updated list to the brand, enabling the brand to select a suitable alternative to complete the campaign. Once all of the podcasters accept the order, the Matching Engine 160 can similarly be configured to notify the brand that the campaign is booked and prompting next steps in furtherance of processing and implementing the campaign.

In an embodiment the processor 100 further comprises an Administration Module 165 configured for implementing the campaigns. The Administration Module can include a payment processing component (not shown) for receiving, from the Brands, the campaign budget amount, e.g., to be held in escrow, and holding the amount until the campaign is confirmed to be completed. The Administration Module can also include a tracking system configured to receive verification from the podcasters (e.g., via computing device 20) that they have presented the advertisements as per the terms of the campaign. The Administration Module can be further configured to release the payment through the payment processing component to the podcasters once the campaign is confirmed, commenced, and/or completed as desired in the particular circumstances.

Advantageously, the ability to quantify the reach of a collection of podcasters solves a particular problem the inventor recognized to exist in the field, whereby, heretofore, a Brand was reluctant to spend advertising dollars on individual podcasters whose reach was deemed not sufficient by the Brand, and a Brand was not able to reliably determine how to aggregate a collection of podcasters whose aggregate reach was sufficient to support the collective advertising spend. In particular, the solution to this problem presented by the present disclosure now enables individual podcasters, whose individual reach is not sufficient to support advertising spend, to be part of a collection of collection of podcasters whose aggregate reach can be quantified, and thereby obtain monetization previously unavailable, and enables Brands to expand their advertising to individual podcaster audiences previously unavailable

### Artificial Intelligence Analytics Engine and Conversation System

In an embodiment, the system server 10, particularly the processor 100, comprises an Analytics Engine 145 that is configured to leverage the validated Podcast Information maintained on an individual podcast and aggregated basis to derive insights for improving performance of podcasts, advertising campaigns and the features and functions of the system server. In an embodiment, the Analytics Engine 143 can be implemented using one or more systems such as an artificial intelligence (AI) system, a neural network (NN), an artificial neural network (ANN), a system of ANNs or NNs, a Bayesian network, an expert system, a fuzzy logic system or other suitable types of machine learning systems. The Analytics Engine 145 comprising such machine learning and predictive algorithms can make the processor a special purpose computer for dynamic quantitative measurement of podcast reach and predictive modelling of podcast reach.

Machine learning is a branch of artificial intelligence (AI) that enables computers to detect patterns and improve performance without direct programming commands. Rather than relying on direct input commands to complete a task, machine learning relies on input data. The data is fed into the machine, a predictive algorithm is selected, parameters for the data are configured, and the machine is instructed to find patterns in the input data through trial and error. The data model formed from analyzing the data is then used to predict future values.

There are various categories of machine learning that can be used to implement the Analytics Engine 145 including supervised, unsupervised, and reinforcement. Supervised machine learning comprises providing the machine with test data and the correct output value of the data. For instance, during supervised learning, values for the output parameter (e.g., predicted growth in reach) are provided to the machine learning system, along with a training data (e.g., Podcast Information for a plurality of podcasts). The algorithm, through trial and error, deciphers the patterns that exist between the input training data and the known output values to create a model that can reproduce the same underlying rules with new data. Examples of supervised learning algorithms include regression analysis, decisions trees, k-nearest neighbors, neural networks, and support vector machines.

If unsupervised learning is used, not all of the variables and data patterns are labeled, forcing the machine to discover hidden patterns and create labels on its own through the use of unsupervised learning algorithms. Unsupervised learning has the advantage of discovering patterns in the data no one previously knew existed. Examples of algorithms used in unsupervised machine learning include k-means clustering (k-NN), association analysis, and descending clustering.

Whereas supervised and unsupervised learning reach an endpoint after a predictive model is constructed and validated through blind testing for accuracy, reinforcement learning continuously improves its model using feedback from application to new empirical data. Algorithms such as Q-learning can be used to train the predictive model through continuous learning using measurable performance criteria (discussed in more detail below).

In an embodiment, the AI-based Analytics Engine can be configured to analyze Podcast Information for an individual podcast and Podcast Information for one or more groups of podcasts to identify trends within the group data that are applicable to model future performance of the individual podcast. In other words, based on the trends identified within the group data and correlations to the individual podcast's Podcast Information, the Analytics Engine can be configured to generate and apply a predictive model for estimating the future performance of the individual podcast under various possible scenarios. For instance, the model can be generated to predict future values for Podcast Information data points relating to podcast reach, as a function of one or more variable model input parameters, which would include Podcast Information data points that can be controlled by the podcaster (e.g., frequency of podcast release and other such podcaster-controlled data points).

In an embodiment, the one or more groups of analyzed podcasts used to identify trends and build the predictive model(s) can be algorithmically defined by the Analytics Engine using various learned, or pre-defined grouping algorithms. The one or more groups used to identify such trends can be varied in size and the degree of similarity within the group and/or to the individual podcast can be varied as well.

Moreover, the Analytics Engine can be configured to utilize the identified trends and predictive models to generate insights for the individual podcast, such as predictions and recommendations for adjusting one or more Podcast Information parameters under the control of the podcaster in order to improve performance of one or more salient podcast metrics (e.g., Podcast Information data points representing the podcast reach). For instance, a determination that the aggregate data exhibits a strong correlation between “true crime” genre podcasts that post at least four days a week and significant growth in podcast reach, can be leveraged by the Analytics Engine 145 to generate a recommendation for another true crime podcast to, say, increase its posting frequency to four days per week.

The analysis of Podcast Information is preferably performed using validated Podcast Information for reliability. As such, in some embodiments, the Analytics Engine can be configured to weight the significance of analyzed input data as well as any resulting trends, models, insights and/or recommendations as a function of whether the underlying Podcast Information is validated and/or how trusted or accurate one or more of the underlying data points are.

In an embodiment, as shown in FIG. 1B, the processor 100 of the System server 10 further comprises a conversational engine referred to as the AI Chatbot 140. As would be understood, a chatbot is a computer program configured to simulate human conversations. The AI Chatbot provides an interface between the Analytics Engine 145 and the podcaster 25 (FIG. 1A) by conveying pertinent insights generated by the Analytics Engine to the podcaster in an understandable way. The Chatbot is configured to communicate with the user in the form of conversational text messages that are transmitted to the user's computing device 20 via the network.

The AI Chatbot is programmed to work independently from a human operator and can answer questions formulated to it in natural language, and otherwise provide information that it determines might be pertinent to the podcaster. In an embodiment, the AI Chatbot can comprise a conversational language generator that provides responses to a user based on a combination of expert-defined conversational structures, predefined scripts and machine learning. Inputs received by the Chatbot from the user can be processed, for example, via natural language processing, to enable the Chatbot to interpret, answer and otherwise utilize the feedback received from the user. Operation of the AI Chatbot can be learned by one or more machine learning models and can be generated over time from unstructured data (e.g., such as feedback from the users via the chatbot), or via structured data (e.g., a training database of conversations), or any combination of the foregoing.

In some embodiments, the Analytics Engine 145 can automatically generate insights identifying issues represented by the Podcast Information (e.g., opportunities for improvement) and associated recommendations for a given podcast, or in response to a user input such as a podcaster's request. The AI Chatbot can be similarly configured to selectively generate messages conveying insights automatically, or in response to a user input. For instance, the Analytics Engine and AI Chatbot can be configured to pre-emptively identify characteristics impacting a given metric represented by the Podcast Information (e.g., podcast's reach, growth, revenue, or other such outcome) and generate recommendations that are provided automatically. Insights and recommendations can be scored or ranked based on a variety of parameters such as, for example, an importance of a given metric to the podcaster, how impactful a recommendation might be on the given metric, the ease of implementing a particular recommendation, and the like. Accordingly, the AI Chatbot can selectively deliver insights/recommendations as a function of such scores, rankings and the like.

In some embodiments, the Analytics Engine and AI Chatbot are implemented using machine learning systems configured analyze direct feedback, responsive actions taken by podcasters and associated results in order to learn podcaster preferences, behavioral characteristics, and derive deeper insights that are useable to dynamically update the Analytics Engine and AI Chatbot algorithms.

In addition, or alternatively to the conversational text-based communication of the AI Chatbot, the processor 100 can also be configured to provide a dashboard interface for displaying, inter alia, the Podcaster Information, analytics, derived insights, recommendations and other such compiled or generated information relating to the podcast. Such information can be provided to the user in various formats including visual graphics, text-based reports and the like.

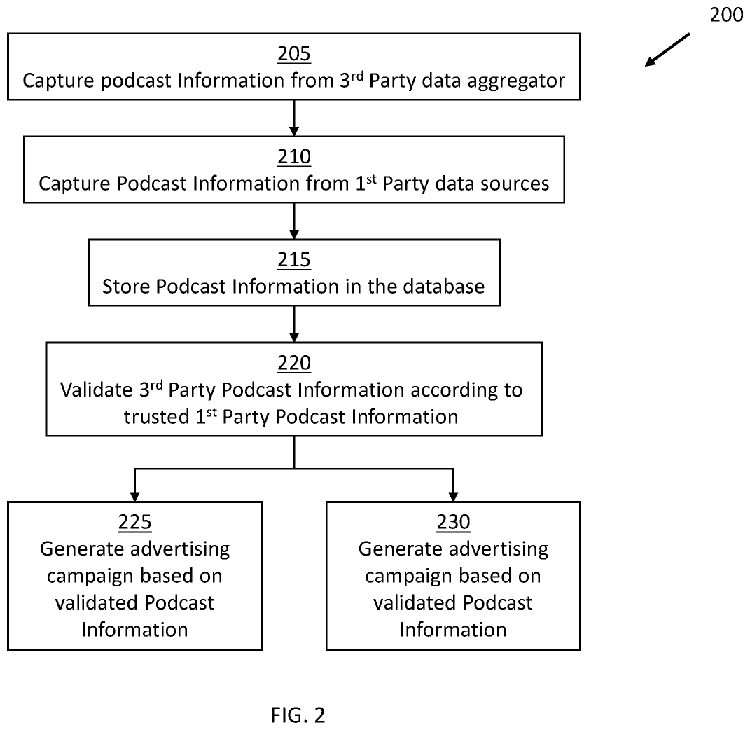

FIG. 2 is a flow diagram illustrating an example method 200 for validating the reach of podcast media content, among other operations described above as being performed by the system server 10 in the context of the podcast distribution network environment 1 shown in FIG. 1A. In an embodiment, the routine 200 can be implemented by the system server 10, and more particularly, the processor 100 as shown and described in connection with FIG. 1B.

At step 205, the Data Aggregation Module (DAM) 150 of the processor captures Podcast Information for a respective podcast from the third-party data aggregator server 30. The Podcast Information comprises Podcast Data and Social Data, wherein Podcast Data includes data points relating to the respective podcast's distribution and attribution, and wherein Social Data includes data points relating to a social media reach of the respective podcast.

At step 210, the DAM of the processor, captures trusted Podcast Information for the respective podcast. Trusted Podcast Data is obtained from one or more of an RSS data feed for the respective podcast, the podcast host server 60, and the streaming platform server 70. Additionally, trusted Social Data is obtained from one or more social media and marketing platforms. In some embodiments, the trusted Podcast Information can be obtained directly by the processor and/or can be captured indirectly from the first-party data aggregator server.

At step 215, the DAM stores, in a database, the Podcast Information including trusted and untrusted Podcast Information. In particular, the Podcast Information is stored in association with a respective account for the respective podcast. Additionally, the untrusted Podcast Information can be annotated in storage as being unvalidated data.

At step 220, the Validation engine/tool 155 of the processor validates the untrusted Podcast Information for the respective podcast according to the trusted Podcast Information for the respective podcast. In particular, validation can include comparing one or more untrusted Podcast Information data points with one or more corresponding trusted Podcast Information data points, and validating the respective podcast as a function of the trusted Podcast Information matching the untrusted Podcast Information to a prescribed degree. Furthermore, validation can also include the step of outputting a validation status indicating that the respective podcast is (or is not) validated.

In some embodiments, the exemplary method 200 for validating the reach of podcast media content can further include step 225, which is directed to generating an advertising campaign for an advertiser based on the validated Podcast Information. In particular, step 225 includes receiving, by the Matching Engine 160 of the processor, campaign criteria from an advertiser, wherein the campaign criteria include prescribed attributes for a plurality of Podcast Information data points and a budget. Step 225 can also include identifying, by the Matching Engine, a first set of podcasts among the plurality of podcasts having respective stored Podcast Information data points that match the prescribed attributes to a prescribed degree. Step 225 can also include ranking, by the Matching Engine, the podcasts within the first set according to their respective validation statuses and how closely their respective stored Podcast Information data points match the prescribed attributes. Step 225 can also include automatically generating, by the Matching Engine, an advertising campaign comprising a subset of podcasts selected from the set as a function of the ranking and the budget.

In some embodiments, the exemplary method 200 for validating the reach of podcast media content can further include step 230, which is directed to analyzing the validated Podcast Information maintained on an individual podcast and aggregated basis to derive insights for improving performance of podcasts, advertising campaigns and the features and functions of the system server. In particular, step 230 can include analyzing, by an analytics engine of the processor, Podcast Information for the respective podcast and Podcast Information for a group of podcasts among the plurality of podcasts. Step 230 can also include identifying trends within the Podcast Information for the group and generating a predictive model for estimating a future performance of the respective podcast as a function of one or more model inputs. Additionally, step 230 can also include generating and providing a podcaster with recommendations for improving the performance of the respective podcast based on the trends and predictive model(s).

Components of the processor 100 discussed above are further discussed herein in reference to FIG. 1B, which shows a non-limiting embodiment of the processor 100 that can be included in the server 10 (shown in FIG. 1A) and configured to implement the features and functionality of the system server 10. As seen in FIG. 1B, the processor 100 can include a computer processor 110 such as a computer processing unit (CPU), a read-only memory (ROM) 115, a random-access memory (RAM) 120, a disk drive (DD) 125, a network interface 130, an input/output (I/O) interface 135, a DAM 150, a Validation Tool 142, Matching Engine 145, and a database (DB) 170. The various components in the processor 110 can be connected to a bus 105 via one or more communication links.

The system bus 105 can be any of several types of bus structures that can further interconnect to a memory bus (with or without a memory controller), a peripheral bus, and a local bus using any of a variety of commercially available bus architectures.

The CPU 110 can be any of various commercially available processors. Dual microprocessors and other multi-processor architectures can also be employed as the CPU 110. The CPU 110 can also be a graphics processing unit (GPU).

The processor 100 includes a non-transitory computer-readable storage medium that can hold executable or interpretable computer code (or instructions) that, when executed by the CPU 110, cause the described steps, processes and methods to be carried out. The computer-readable medium can be provided in the ROM 115, RAM 120, DD 125, DB 170, or an external computer-readable medium connected to the processor 100 via the network interface 130 or the I/O interface 135. The computer readable medium can include functional modules, for instance, sections of computer code that, when executed by the CPU 110 cause the steps described or contemplated in the description to be carried out.

A basic input/output system (BIOS) can be stored in a non-volatile memory in the processor 100, such as, for example, the ROM 115. The ROM 115 can include a ROM, an erasable programmable read-only memory (EPROM), or an electrically erasable programmable read-only memory (EEPROM). The BIOS can contain the basic routines that help to transfer information between components within the processor 100, such as during start-up. The RAM 120 can include a high-speed RAM such as static RAM for caching data.

The disk drive (DD) 125 can include a hard drive, such as, for example, an enhanced integrated drive electronics (EIDE) drive, or a serial advanced technology attachments (SATA) drive. The DD 125 can include an optical disk drive that can read/write from/to a compact disk read-only memory (CD-ROM) disk (not shown), or read from or write to other high capacity optical media such as a digital video disk (DVD). The DD 125 can be configured for external use in a suitable chassis (not shown). The DD 125 can be connected to the system bus 105 by a hard disk drive interface (not shown) and an optical drive interface (not shown), respectively. The hard disk drive interface (not shown) can include a Universal Serial Bus (USB) (not shown) or an IEEE 1394 interface (not shown) for external applications.

The DD 125 and associated computer-readable media can provide nonvolatile storage of data, data structures, or computer-executable instructions. The DD 125 can accommodate the storage of any data in a suitable digital format. The DD 125 can include one or more apps that are used to execute aspects of the architecture described in this specification.

The database 170 can include a database management system (DBMS) (not shown), file-based storage system or any storage medium which can receive and process queries to locate and retrieve data from the database 170. The database 170 can be a computer readable storage medium that is provided locally, as shown in FIG. 1B. In addition or alternatively, the database 170 can be located remotely, such as a cloud-based data storage system that is accessible via a communication connection. The database 170 include a DBMS such as, for example, SQL, MySQL, Oracle, Access, or Unix.

A number of program modules can be stored in the DD 125, ROM 115, or RAM 120, including an operating system (not shown), one or more application programs (not shown), other program modules (not shown), and program data (not shown). Any (or all) of the operating system, application programs, program modules, and program data can be cached in the RAM 120 as executable sections of computer code.

The network interface 130 can be connected to the network 50 (shown in FIG. 1A). The network interface 130 can include a wired or a wireless communication network interface (not shown) or a modem (not shown). When used in a local area network (LAN), the processor 100 can be connected to the LAN network through the wired or wireless communication network interface; and, when used in a wide area network (WAN), the processor 100 can be connected to the WAN network through the modem. The modem (not shown) can be internal or external and wired or wireless. The modem can be connected to the system bus 105 via, for example, a serial port interface (not shown).

The I/O interface 135 can receive commands and data from an operator via a user interface device (not shown), such as, for example, a keyboard (not shown), a mouse (not shown), a pointer (not shown), a microphone (not shown), a speaker (not shown), or a display (not shown). The received commands and data can be forward to the CPU 110 from the I/O interface 135 as instruction and data signals via the bus 105.

As further shown in FIG. 1B and described herein, the processor 100 can include the data aggregation module (DAM) 150, the Validation Tool 155, the Matching Engine 160, the Campaign Administration Module 165, the Analytics Engine 145, and the conversational engine referred to as the AI Chatbot 145, among other functional modules. It should be understood that such hardware and/or software-based processing modules can be integrated with the CPU 110 or provided separately, as seen in FIG. 1B.

The terms “a,” “an,” and “the,” as used in this disclosure, means “one or more,” unless expressly specified otherwise.

The term “communicating device,” as used in this disclosure, means any hardware, firmware, or software that can transmit or receive data packets, instruction signals or data signals over a communication link. The communicating device can include a computer or a server. The communicating device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, Wi-Fi, WiMAX, IEEE 802.11, DECT, 0G, 1G, 2G, 3G, 4G or 5G cellular standards, or Bluetooth.

The terms “computer” or “computing device,” as used in this disclosure, are used synonymously and means any machine, device, circuit, component, or module, or any system of machines, devices, circuits, components, or modules which are capable of manipulating data according to one or more instructions, such as, for example, without limitation, a processor, a microprocessor, a graphics processing unit, a central processing unit, a general purpose computer, a super computer, a personal computer, a laptop computer, a palmtop computer, a notebook computer, a tablet device, a mobile phone or smartphone device, a desktop computer, a workstation computer, a server, a server farm, a computer cloud, or an array of processors, microprocessors, central processing units, general purpose computers, super computers, personal computers, laptop computers, palmtop computers, notebook computers, tablet devices, mobile phone or smartphone devices, desktop computers, workstation computers, or servers.

The term “computer-readable medium,” as used in this disclosure, means any storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read. The computer-readable medium can include a “Cloud,” which includes a distribution of files across multiple (for example, thousands of) memory caches on multiple (for example, thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, Wi-Fi, WiMAX, IEEE 802.11, DECT, 0G, 1G, 2G, 3G, 4G, or 5G cellular standards, or Bluetooth.

The term “database,” as used in this disclosure, means any combination of software or hardware, including at least one application or at least one computer. The database can include a structured collection of records or data organized according to a database model, such as, for example, but not limited to at least one of a relational model, a hierarchical model, or a network model. The database can include a database management system application (DBMS) as is known in the art. The at least one application may include, but is not limited to, for example, an application program that can accept connections to service requests from clients by sending back responses to the clients. The database can be configured to run the at least one application, often under heavy workloads, unattended, for extended periods of time with minimal human direction.

The terms “including,” “comprising” and their variations, as used in this disclosure, mean “including, but not limited to,” unless expressly specified otherwise.

The term “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, or the Internet, any of which can be configured to communicate data via a wireless or a wired communication medium. These networks can run a variety of protocols not limited to TCP/IP, IRC or HTTP.

The term “server,” as used in this disclosure, means any combination of software or hardware, including at least one application or at least one computer to perform services for connected clients as part of a client-server architecture. The at least one server application can include, but is not limited to, for example, an application program that can accept connections to service requests from clients by sending back responses to the clients. The server can be configured to run the at least one application, often under heavy workloads, unattended, for extended periods of time with minimal human direction. The server can include a plurality of computers configured, with the at least one application being divided among the computers depending upon the workload. For example, under light loading, the at least one application can run on a single computer. However, under heavy loading, multiple computers can be required to run the at least one application. The server, or any if its computers, can also be used as a workstation.

The term “transmission,” as used in this disclosure, means the conveyance of signals via electricity, acoustic waves, light waves and other electromagnetic emissions, such as those generated with communications in the radio frequency (RF) or infrared (IR) spectra. Transmission media for such transmissions can include coaxial cables, copper wire and fiber optics, including the wires that comprise a system bus coupled to the processor.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, and by structures and functions or steps which are equivalent to these recitations.

What is claimed is:

1. A system for validating a reach of podcast media content within a podcast distribution network environment, the podcast distribution network including one or more of a podcast host server, a streaming platform server, a social media server, a first party data aggregator server and a third-party data aggregator server, the system comprising:
a system server including:
a communication network interface communicatively connecting the system server with one or more servers within the podcast distribution network environment,
a non-transitory computer readable storage medium,
a processor in electronic communication with the computer readable storage medium and the communication network interface,
one or more software modules comprising executable instructions stored in the storage medium, wherein the one or more software modules are executable by the processor and include:
a data aggregation module (DAM) that configures the processor to, for each respective podcast of a plurality of podcasts:
capture Podcast Information for a respective podcast from the third-party data aggregator server, wherein the Podcast Information comprises Podcast Data and Social Data, wherein Podcast Data includes information relating to the respective podcast's distribution and attribution, and wherein Social Data includes usage data and metrics relating to a social media reach of the respective podcast, wherein Podcast Information obtained from the third party data aggregator server is untrusted Podcast Information,
capture trusted Podcast Information for the respective podcast, wherein trusted Podcast Data is obtained from one or more of an RSS data feed for the respective podcast, the podcast host server, and the streaming platform server, and wherein trusted Social Data is obtained from one or more social media and marketing platforms, wherein the trusted Podcast Information is obtained directly by the DAM or is captured indirectly from the first-party data aggregator server,
store the Podcast Information including trusted and untrusted Podcast Information in a database in association with a respective account for the respective podcast, wherein the untrusted Podcast Information is annotated in storage as being unvalidated data; and
a validation tool that configures the processor to, for each respective podcast among the plurality of podcasts:
validate the untrusted Podcast Information for the respective podcast according to the trusted Podcast Information for the respective podcast by,
comparing one or more untrusted Podcast Information data points with one or more corresponding trusted Podcast Information data points,
validating the respective podcast as a function of the trusted Podcast Information matching the untrusted Podcast Information to a prescribed degree, and
outputting a validation status indicating that the respective podcast is validated.

2. The system of claim 1, further comprising:
a matching engine that configures the processor to:
receive campaign criteria from an advertiser, the campaign criteria including prescribed attributes for a plurality of Podcast Information data points and a budget,
identify a first set of podcasts among the plurality of podcasts having respective stored Podcast Information data points that match the prescribed attributes to a prescribed degree, and
rank the podcasts within the first set according to their respective validation statuses and how closely their respective stored Podcast Information data points match the prescribed attributes,
automatically generate an advertising campaign comprising a subset of podcasts selected from the set as a function of the ranking and the budget.

3. The system of claim 1, further comprising:
an analytics engine that configures the processor to,
analyze Podcast Information for the respective podcast and Podcast Information for a group of podcasts among the plurality of podcasts, to
identify trends within the Podcast Information for the group, and
generate, as a function of the identified trends, a predictive model for estimating a future performance of the respective podcast as a function of one or more model inputs.

4. The system of claim 3, wherein the analytics engine further configures the processor to identify, based on the predictive model and the stored Podcast Information for the respective podcast, a recommendation for improving the performance of the respective podcast.

5. The system of claim 4, wherein the analytics engine comprises one or more of: an artificial intelligence (AI) system, a neural network (NN), and an artificial neural network (ANN).

6. The system of claim 4, wherein the analytics engine configures the processor to analyze the Podcast Information for the respective podcast and Podcast Information for a group of podcasts as a function of a respective validation status.

7. The system of claim 4, further comprising:
a conversational engine that configures the processor to provide the recommendation to a podcaster associated with the respective podcast via a user interface.

8. The system of claim 7, wherein the conversational engine comprises an AI chatbot configured to simulate human conversation.

9. The system of claim 1, wherein the validation tool configures the processor to calculate comparison scores for a plurality of Podcast Information data points and validate the respective podcast as a function of a weighted average of the comparison scores exceeding a prescribed threshold, and wherein the validation tool further configures the processor to annotate the account for the respective podcast in the database with the validation status.

10. The system of claim 1, wherein the DAM configures the processor to replace any untrusted Podcast Information data points for the respective podcast in the database with any corresponding trusted Podcast Information data points.

11. A method for validating a reach of podcast media content within a podcast distribution network environment, the podcast distribution network including one or more of a podcast host server, a streaming platform server, a social media server, a first party data aggregator server and a third-party data aggregator server, the method being implemented by a processor of a system server, and the method comprising:
capturing, by a data aggregation module of the processor, Podcast Information for a respective podcast from the third-party data aggregator server, wherein the Podcast Information comprises Podcast Data and Social Data, wherein Podcast Data includes data points relating to the respective podcast's distribution and attribution, and wherein Social Data includes data points relating to a social media reach of the respective podcast, wherein Podcast Information obtained from the third party data aggregator server is untrusted Podcast Information;
capturing, by the data aggregation module of the processor, trusted Podcast Information for the respective podcast, wherein trusted Podcast Data is obtained from one or more of an RSS data feed for the respective podcast, the podcast host server, and the streaming platform server, and wherein trusted Social Data is obtained from one or more social media and marketing platforms, wherein the trusted Podcast Information is obtained directly by the processor or is captured indirectly from the first-party data aggregator server;
storing, by the data aggregation module in a database, the Podcast Information including trusted and untrusted Podcast Information, wherein the Podcast Information is stored in association with a respective account for the respective podcast, wherein the untrusted Podcast Information is annotated in storage as being unvalidated data;
validating, by a validation engine of the processor, the untrusted Podcast Information for the respective podcast according to the trusted Podcast Information for the respective podcast by,
comparing one or more untrusted Podcast Information data points with one or more corresponding trusted Podcast Information data points,
validating the respective podcast as a function of the trusted Podcast Information matching the untrusted Podcast Information to a prescribed degree, and
outputting a validation status indicating that the respective podcast is validated.

12. The method of claim 11, further comprising:
receiving, by matching engine of the processor, campaign criteria from an advertiser, the campaign criteria including prescribed attributes for a plurality of Podcast Information data points and a budget,
identifying, by the matching engine, a first set of podcasts among the plurality of podcasts having respective stored Podcast Information data points that match the prescribed attributes to a prescribed degree,
ranking, by the matching engine, the podcasts within the first set according to their respective validation statuses and how closely their respective stored Podcast Information data points match the prescribed attributes; and
automatically generating, by the matching engine, an advertising campaign comprising a subset of podcasts selected from the set as a function of the ranking and the budget.

13. The method of claim 11, further comprising:
analyzing, by an analytics engine of the processor, Podcast Information for the respective podcast and Podcast Information for a group of podcasts among a plurality of podcasts,
identifying, based on the analysis, trends within the Podcast Information for the group, and
generating, by the analytics engine, as a function of the identified trends, a predictive model for estimating a future performance of the respective podcast as a function of one or more model inputs.

14. The method of claim 13, further comprising:
generating, by the analytics engine based on the predictive model and the stored Podcast Information for the respective podcast, a recommendation for improving the performance of the respective podcast.

15. The method of claim 14, wherein the analytics engine comprises one or more of: an artificial intelligence (AI) system, a neural network (NN), and an artificial neural network (ANN).

16. The method of claim 14, wherein the analytics engine analyzes the Podcast Information for the respective podcast and Podcast Information for a group of podcasts as a function of a respective validation status.

17. The method of claim 14, further comprising:
providing, by a conversational engine of the processor, the recommendation to a podcaster associated with the respective podcast, wherein the recommendation is provided to the podcaster via a user interface.

18. The method of claim 11, wherein the validation step comprises:
one or more of:
performing cross-channel validation of untrusted Podcast Data data points based on trusted Social Data data points, and
performing cross-channel validation of untrusted Social Data data points based on trusted Podcast Data data points.

19. The method of claim 11, wherein the validation step further comprises:
calculating, based on the comparison, a comparison score for a plurality of Podcast Information data points and
validating the respective podcast as a function of a weighted average of the comparison scores exceeding a prescribed threshold, and
annotating the account for the respective podcast in the database with the validation status.

20. The method of claim 11, further comprising:
replacing, by the DAM, any untrusted Podcast Information data points for the respective podcast in the database with any corresponding trusted Podcast Information data points.
